(19) United States
(12) Patent Application Publication
(10) Pub. No.: US 2012/0219426 A1
(43) Pub. Date: Aug. 30, 2012

(54) BLADE FOR A TURBINE

(75) Inventor: Azad Hessamodini, Shenton Park (AU)

(73) Assignee: WINDWORKS ENGINEERING LIMITED, Limassol (CY)

(21) Appl. No.: 13/390,890

(22) PCT Filed: Aug. 20, 2010
(86) PCT No.: PCT/AU2010/001077

§ 371 Date: May 3, 2012

(30) Foreign Application Priority Data
Aug. 20, 2009 (AU) 2009903951

(51) Int. Cl. F03D 3/06

(52) U.S. Cl. 416/232; 416/223 R

(57) ABSTRACT

The present disclosure provides a blade for a wind turbine. The wind turbine has an axis about which in use the blade rotates. The blade is arranged for orientation along the axis and has a predetermined twisted shape. The blade has a first and an opposite second side portion. The first and second side portions have edges and are coupled together at the edges. The first and second side portions are shaped such that a blade body is formed that is shaped such that maintaining the predetermined twisted shape of the blade is facilitated.

### FIELD OF THE INVENTION

The present invention broadly relates to a blade for a wind turbine. Particularly, although not exclusively, the present invention relates to a blade for a vertical axis wind turbine.

### BACKGROUND OF THE INVENTION

Vertical axis wind turbines, which have a rotatable blade assembly arranged in a substantially vertical direction, are not dependent on wind direction like their horizontal axis wind turbine counterparts. Vertical axis wind turbines come in a variety of forms, including Darrieus or so called ‘eggbeater’ wind turbines and Savonius wind turbines. Another type of vertical axis wind turbine is described in PCT international publication no. WO 03/058061 entitled “A Vertical Axis Turbine”.

There is now great interest in using vertical axis wind turbines to harness renewable energy. Especially blades for wind turbines of the type described in PCT international publication no. WO 03/058061 often have relatively heavy designs as they often require supporting frames. There is a need for technological advancement.

### SUMMARY OF THE INVENTION

The present invention provides in a first aspect a blade for a wind turbine, the wind turbine having an axis about which in use the blade rotates, the blade being arranged for orientation along the axis and having a predetermined longitudinally twisted shape, the blade having a first and an opposite second side portion, the first and second side portions having edges and being coupled together at the edges, the first and second side portions being shaped such that a blade body is formed that facilitates maintaining the predetermined longitudinally twisted shape.

The blade typically is a blade for a vertical axis wind turbine.

In one specific embodiment of the present invention the formed blade body is shaped such that support for maintaining the predetermined longitudinally twisted shape is provided by the formed blade body without a support structure supporting the blade.

Embodiments of the present invention have significant practical advantages. As the first and second side portions typically support each other, light-weight construction of the blade is facilitated.

The blade may have first and second ends and in one specific embodiment of the present invention the blade is twisted between the ends in a manner such that at least portions of the first and second ends have an angular orientation that differs by substantially 120°. In other variations the first and second ends may have portions that differ in angular orientation by another suitable angle that may be in the range of 90°-150°, such as substantially 90°, 100°, 110°, 130°, 140° or 150°.

The blade may be arranged so that in use an axis of the twist is substantially parallel the axis of rotation of the wind turbine and may also coincide with the axis of rotation.

The blade body may be largely hollow or may be charged with a filler material, such as a suitable foam that facilitates structural stability.

The first and second side portions of the blade may be formed from any suitable material, such as fibre glass, moulded plastic or a metallic material.

In one example the side portions form a sealed blade body.

The blade may have any suitable length, for example 3-5 m, 5-10 m or even longer. Further, the blade may have any suitable width, such as 1-1.5 m, or 1.5-3 m or more.

The length to width aspect ratio may for example be of the order of 1:1-3:1, or 1.5:1-2.5:1 or 1.6:1-2.2:1. In one specific example the aspect ratio is 1.61:1.

The blade typically is a substantially rectangular element that is twisted.

The present invention provides in a second aspect a blade assembly for a wind turbine, the blade assembly comprising a mast and being arranged for orientation along an axis of rotation, the blade assembly further comprising at least two blades and a plurality of n coupling members that couple the at least two blades to each other,
wherein less than n of the coupling members are coupled to the mast; and
wherein the blade assembly is arranged so that the at least two blades support each other in a manner such that in use maintaining a predetermined shape of each of the at least two blades is facilitated.

In one example the blades are arranged so that coupling of the blades to each other is required to maintain the predetermined shape. Alternatively, the coupling may facilitate maintaining the shape of the blades, but may not necessarily be required to maintain the shape. In this case each blade may be provided in the form of the blade in accordance with the first aspect of the present invention.

The coupling member may be provided in the form of struts or bars or the like. Each coupling member may be arranged for coupling two or more blades to each other. In one example the blades are coupled to each other by a plurality of the coupling members that are distributed along the blades.

In one specific embodiment the blade assembly comprises 3 blades and the coupling members are arranged so that each blade is coupled to the remaining two blades and each coupling member couples two blades to each other.

Each coupling member may comprise a plurality of coupling elements.

The blades of the blade assembly may be distributed at 120° around an axis of rotation of the wind turbine. In one example the blades are twisted by substantially 120°.

The blades may be arranged so that each blade has a first end that has a portion that has substantially the same angular orientation as a second end of an adjacent blade.

The blade assembly typically is a blade assembly for a vertical axis wind turbine.

The present invention provides in a third aspect a wind turbine having the blade or the blade assembly in accordance with the first or second aspect of the present invention respectively.

The invention will be more fully understood from the following description of specific embodiments of the invention. The description is provided with reference to the accompanying drawings.

### BRIEF DESCRIPTION OF THE DRAWINGS

FIG. 1 shows a blade assembly in accordance with a specific embodiment of the present invention;

FIG. 2a shows a cross-sectional representation of a lower portion of a blade in accordance with a specific embodiment of the present invention;

FIG. 2b shows a cross-sectional representation of an upper portion of a blade in accordance with a specific embodiment of the present invention;

FIG. 3 shows a mast portion of a blade assembly in accordance with a specific embodiment of the present invention;

FIG. 4 shows coupling members of a blade assembly in accordance with a specific embodiment of the present invention;

FIG. 5 shows a perspective view a bottom portion of a blade assembly in accordance with a specific embodiment of the present invention; and

FIG. 6 shows a perspective side view of a blade assembly in accordance with a specific embodiment of the present invention.

### DETAILED DESCRIPTION OF SPECIFIC EMBODIMENTS

Embodiments of the present invention generally relate to a blade for a wind turbine, such as a vertical axis wind turbine. The blade is twisted along the axis of the wind turbine and has first and second side portions. The first and second side portions are coupled together at edges and shaped such that a blade body is formed and maintaining of the twisted shape of the blade is facilitated.

In this example the first and second side portions are attached to each other and the formed blade body is shaped so that no further support structure is required for maintaining the blade in the twisted shape when used in a blade assembly for the wind turbine. The resulting three-dimensional shape consequently is selected so that the blade is largely self-supporting.

An interior portion of the formed blade body may be hollow or may be filled with a suitable material, such as foam.

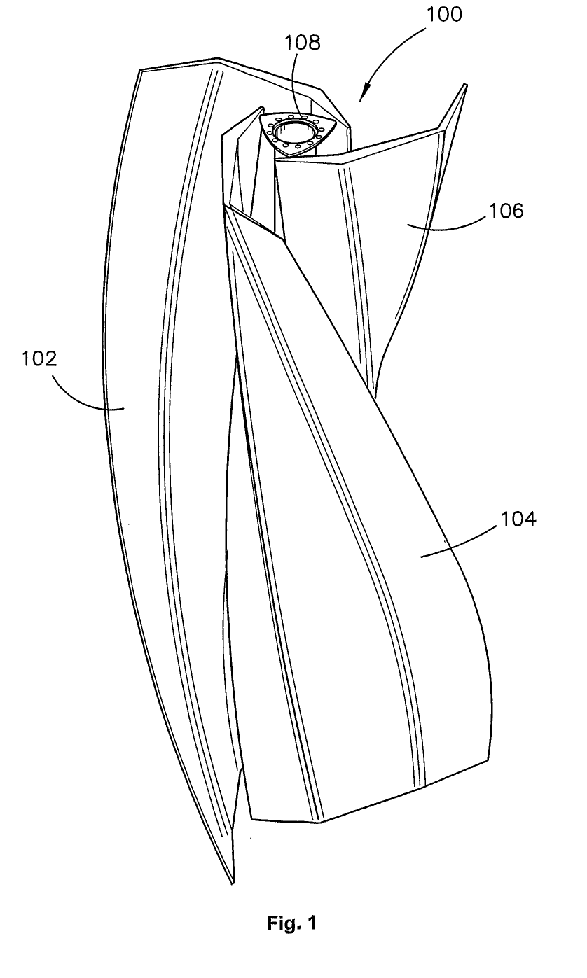

Referring initially to FIG. 1, a blade assembly 100 for a wind turbine is now described. The blade assembly 100 comprises blades 102, 104 and 106. The blades are attached to a central mast 108. Each blade 102, 104 and 106 is twisted along the mast 108 in a manner such that lower and upper ends of each blade are rotated relative to each other by approximately 120°. The blades are rotated by 120° relative to each other about the axis of rotation of the wind turbine. A bottom portion of (not shown) of the mast 108 is arranged for attachment to a generator so that a wind turbine is formed. In this embodiment the blades are arranged so that each blade has a portion at a lower end that has the same angular orientation as a portion at an upper end of an adjacent blade.

The blades 102, 104 and 106 are approximately 5.5 m long and 1.8 m wide. In other variations the blades may have any other suitable length or width. For example, each blade 100 may have a length of 3-5 m, 5-10 m or even longer. Further, each blade may have any suitable width, such as 1-1.5 m, or 1.5-3 m or more.

In this specific example the aspect ratio is 1.61:1, but may alternatively be any other suitable ratio.

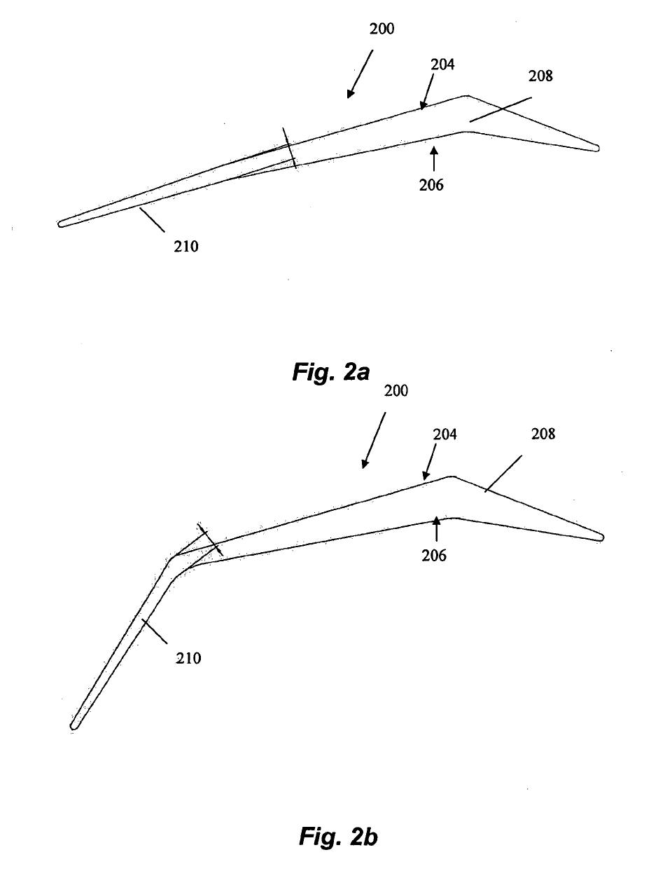

FIGS. 2a and 2b show cross-sectional shapes 200 and 202 of each of the blades 102, 104 and 106 at upper and lower ends, respectively. Each blade has side portions 204 and 206. As can been seen in FIGS. 2a and 2b, the side portions 204 and 206 are not parallel and are attached at edges. In this example a sealed body is formed by the side portions 204 and 206.

The side portions 204 and 206 are shaped so that each blade 102, 106 and 108 is self-supporting. The side portions 204 and 206 may for example be formed from fibreglass or a molded plastics material. Alternatively, the side portions 204 and 206 may be formed from a metallic material. The side portions 204 and 206 may be attached to each other during fabrication, such as during a molding process and may also be integrally formed. Alternatively, the side portions 204 and 206 may be formed separately and then attached to each other using fasteners or suitable adhesive material or welding (for example). As mentioned above, an interior space 208 may be hollow and may also be filled with a suitable material, such as a suitable foam or any other light weight material. The foam may be adhered to an inner surface of the side portions 204 and 206, which further increases stability of the blades 102, 104 and 108.

As can be seen from FIGS. 1, 2a and 2b, each blade 102, 104 and 106 has a longitudinal edge portion 210 that changes orientation relative to other portions of the blades 102, 104 and 106 along by approximately 40°. It is to be appreciated that in variations of the described embodiment all portions of the blades 102, 104 and 106 may experience the same change in angular orientation along the length of each blade.

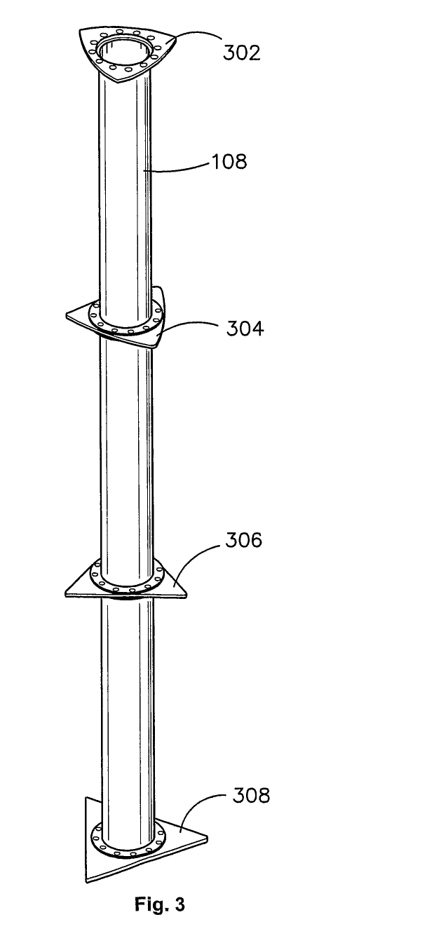

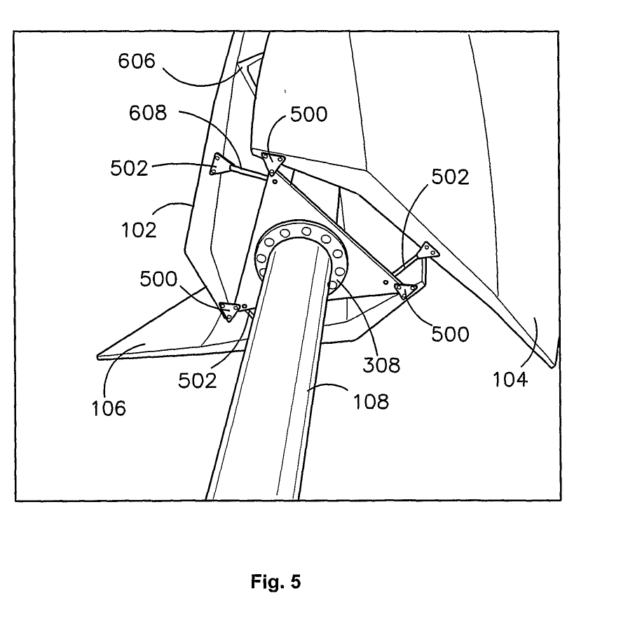

FIG. 3 shows the mast 108 in more detail. The mast 108 comprises coupling elements 302, 304, 306 and 308. In this example, the coupling elements are basically of a triangular shape and are attached to a central portion of the mast. The coupling elements are arranged for receiving bolts and struts and the like, which are used to couple the blades 102, 104 and 106 to the coupling elements and thereby to the mast 108. FIG. 5 shows a perspective bottom view of a blade assembly showing the coupling element 308, the mast 108 and the blades 102, 104 and 106 in more detail. The blades 102, 104 and 106 are attached to the coupling element 308 by way of suitable bolts, (and struts 500 and 502). The blades 102, 104 and 106 are attached to coupling elements 306, 304 and 302 in a similar manner.

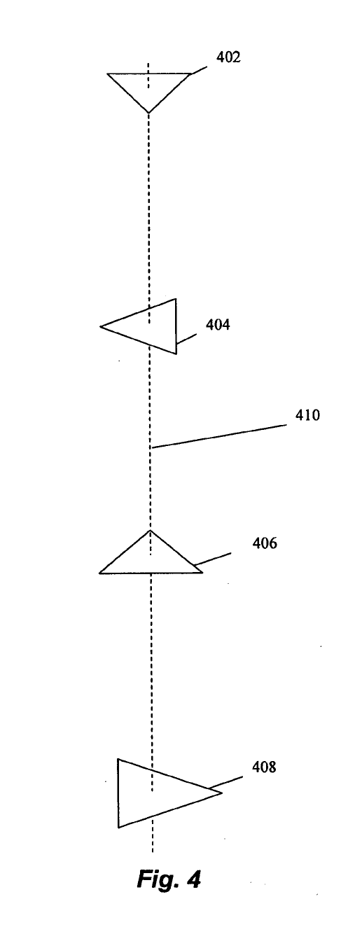

FIG. 4 shows an alternative embodiment in which coupling elements 402, 404, 406 and 408 are not connected to one another and only the bottom 2 coupling members 408 and 406 are coupled to a mast (not shown). In this example, coupling elements 402, 404, 406 and 408 are of a similar triangular shape to the coupling elements 302, 304, 306 and 308 of FIG. 3. Further, each coupling element 402, 404, 406 and 408 is of a similar orientation to each corresponding coupling element 302, 304, 306 and 308 and are arranged in a vertical configuration sharing a common axis 410. It is to be understood however that the coupling elements 402, 404, 406 and 408 may be of any appropriate shape or orientation and more than 2 or only 1 coupling member may be coupled to the mast.

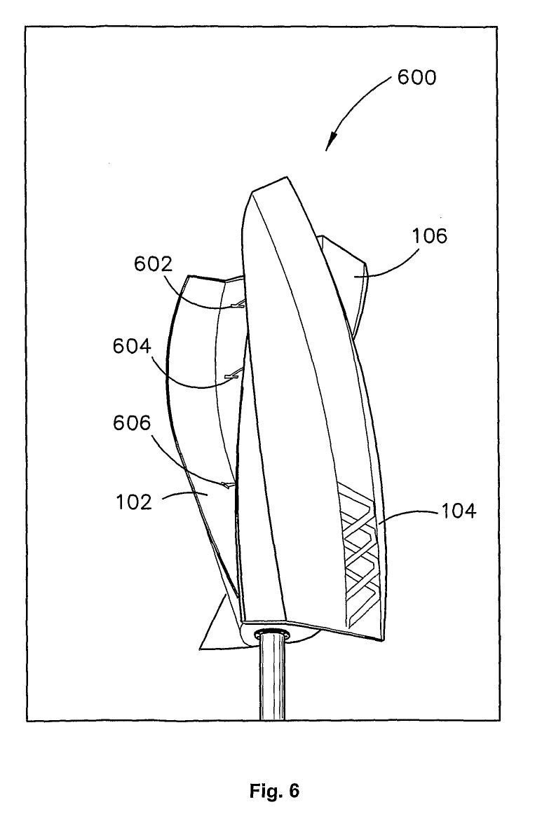

FIG. 6 shows a perspective side view of a blade assembly 600 that forms a part of a wind turbine. The blades 102, 104 and 106, also shown in FIG. 5, are, in this embodiment, coupled to each other using struts 602, 604, 606 and 608 (shown in FIG. 5) which are in turn connected to respective coupling elements 302, 304, 306 and 308. In this manner, respective struts and coupling elements each couple two blades to each other and each blade is coupled to the remaining two blades of the blade assembly. The coupling of the blades to each other facilitates structural stability. As described above, each blade is essentially self-supporting and consequently the struts 602, 604, 606 and 608, together with respective coupling elements 302, 304, 306 and 308 facilitate maintaining a predetermined shape.

In a variation of the embodiment shown in FIGS. 5 and 6, the blades may not necessarily be self-supporting, but may be attached to each other using coupling members so that the blades support each other and structural stability is provided even if each blade, when decoupled, would not provide sufficient structural stability.

Although the invention has been described with reference with particular example, it will be appreciate by those skilled in the art that the invention may be embodied in many forms. For example, the blades 102, 104 and 106 may be twisted by any suitable angle and may be provided in any suitable form. Further, the mast 108 may not necessarily project along the entire length of the blade assembly and the blade may be attached to the mast using a variety of possible attachment elements. Further, the blade assembly may not necessarily comprise for example 2 or 4 blades.

Reference that is being made to PCT international publication no. WO 03/058061 does not constitute an admission that that publication is part of the common general knowledge of a skilled person in Australia or any other country.

1. A blade for a wind turbine, the wind turbine having an axis about which in use the blade rotates, the blade being arranged for orientation along the axis and having a predetermined longitudinally twisted shape, the blade having a first and an opposite second side portion, the first and second side portions having edges and being coupled together at the edges, the first and second side portions being shaped such that a blade body is formed that facilitates maintaining the predetermined longitudinally twisted shape.

2. The blade of claim 1 wherein the blade is a blade for a vertical axis wind turbine.

3. The blade of claim 1 wherein the formed blade body is shaped such that support for maintaining the predetermined twisted shape is provided by the formed blade body without a support structure supporting the blade.

4. The blade of claim 1 having first and second ends and wherein the blade is twisted in a manner such that at least portions of the first and second ends have an angular orientation that differs by substantially 120°.

5. The blade of claim 1 wherein the blade is arranged so that in use an axis of the twist substantially coincides with the axis of rotation.

6. The blade of claim 1 wherein the blade body is largely hollow.

7. The blade of claim 1 wherein the blade body is charged with a filler material.

8. The blade of claim 1 wherein the side portions form a sealed blade body.

9. The blade of claim 1, wherein the length to width aspect ratio of the blade is in the range of 1:1 to 3:1.

10. The blade of claim 1 being a substantially rectangular element that is twisted.

11. A blade assembly for a wind turbine, the blade assembly comprising a mast and being arranged for orientation along an axis of rotation, the blade assembly further comprising at least two blades and a plurality of n coupling members that couple the at least two blades to each other,
wherein less than n of the coupling members are coupled to the mast; and
wherein the blade assembly is arranged so that the at least two blades support each other in a manner such that in use maintaining a predetermined shape of each of the at least two blades is facilitated.

12. The blade assembly of claim 11 wherein the blades are arranged so that coupling of the blades to each other is required to maintain the predetermined shape.

13. The blade assembly of claim 11 wherein the blades are arranged so that the coupling facilitates maintaining the shape of the blades.

14. The blade assembly of claim 13 wherein each blade is provided in the form of the blade of a blade for a wind turbine, the wind turbine having an axis about which in use the blade rotates, the blade being arranged for orientation along the axis and having a predetermined longitudinally twisted shape, the blade having a first and an opposite second side portion, the first and second side portions having edges and being coupled together at the edges, the first and second side portions being shaped such that a blade body is formed that facilitates maintaining the predetermined longitudinally twisted shape.

15. The blade assembly of claim 11 wherein each coupling member is arranged for coupling 2 blades to each other.

16. The blade assembly of claim 11 comprising 3 blades.

17. The blade assembly of claim 16 wherein the blades of the blade assembly are distributed at 120° around an axis of rotation of the turbine.

18. The blade assembly of claim 11 wherein the blades are arranged so that each blade has a first end that has a portion that has substantially the same angular orientation as a second end of an adjacent blade.

19. The blade assembly of claim 11 wherein the blade assembly is a blade assembly for a vertical axis wind turbine.

20. A wind turbine having the blade assembly of claim 11.
